(19) United States
(12) Patent Application Publication
(10) Pub. No.: US 2016/0378138 A1
(43) Pub. Date: Dec. 29, 2016

(54) INTEGRATION OF FORCE TRANDUCER INTO TABLET TO MEASURE WEIGHT

(71) Applicant: Intel Corporation, Santa Clara, CA (US)

(72) Inventor: Nicholas W. Oakley, Portland, OR (US)

(73) Assignee: Intel Corporation, Santa Clara, CA (US)

(21) Appl. No.: 14/752,904

(22) Filed: Jun. 27, 2015

(51) Int. Cl. G06F 1/16; G01G 23/37

(52) U.S. Cl. CPC G06F 1/1633; G06F 1/163; G01G 23/3707; G01G 23/3742

(57) ABSTRACT

Methods and apparatus relating to integration of force transducer into a mobile computing device to measure weight are described. In an embodiment, logic receives a load detection signal from one or more load sensors coupled to the mobile computing device. The one or more load sensors may be integrated into a chassis of the mobile computing device. Other embodiments are also disclosed and claimed.

### FIELD

The present disclosure generally relates to the field of electronics. More particularly, an embodiment relates to techniques for integration of force transducer into tablet to measure weight.

### BACKGROUND

Tablets are gaining popularity, in part, because of their decreasing prices and increasing performance. Another reason for their increasing popularity may be due to the fact that some portable computing devices may be operated at many locations or for new usage models.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 4-5 illustrate block diagrams of embodiments of computing systems, which may be utilized to implement various embodiments discussed herein.

FIGS. 2A, 2A1, 2B, 2B1, 2C, and 3 illustrate various views of computing devices, according to some embodiments.

FIG. 6 illustrates a block diagram of an SOC (System On Chip) package in accordance with an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

As discussed above, portable computing devices (such as tablets) are gaining popularity, in part, because of their decreasing prices and increasing performance. Another reason for their increasing popularity may be due to the fact that some portable computing devices may be operated at many locations or for new usage models.

To this end, some embodiments integrate one or more force sensors into portable computing devices (such as tablets) to measure weight. As discussed herein, a force sensor may be interchangeably referred to as a load sensor, a force transducer, or a load transducer. In an embodiment, one or more force sensors are integrated into the chassis of a tablet form factor to allow measurement of weight.

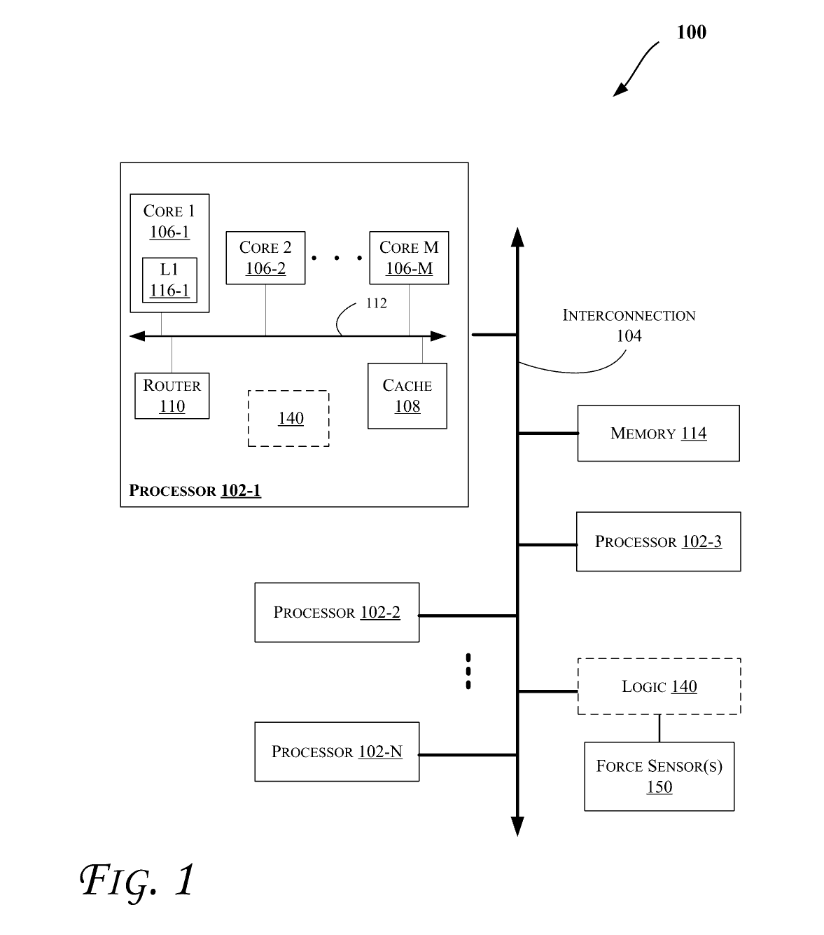

Some embodiments may be applied in computing systems that include one or more processors (e.g., with one or more processor cores), such as those discussed with reference to FIGS. 1-6, including for example mobile computing devices such as a smartphone, tablet, UMPC (Ultra-Mobile Personal Computer), laptop computer, Ultrabook™ computing device, wearable devices (such as smart watch, smart glasses, and the like), etc. More particularly, FIG. 1 illustrates a block diagram of a computing system 100, according to an embodiment. The system 100 may include one or more processors 102-1 through 102-N (generally referred to herein as “processors 102” or “processor 102”). The processors 102 may be general-purpose CPUs (Central Processing Units) and/or GPUs (Graphics Processing Units) in various embodiments. The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

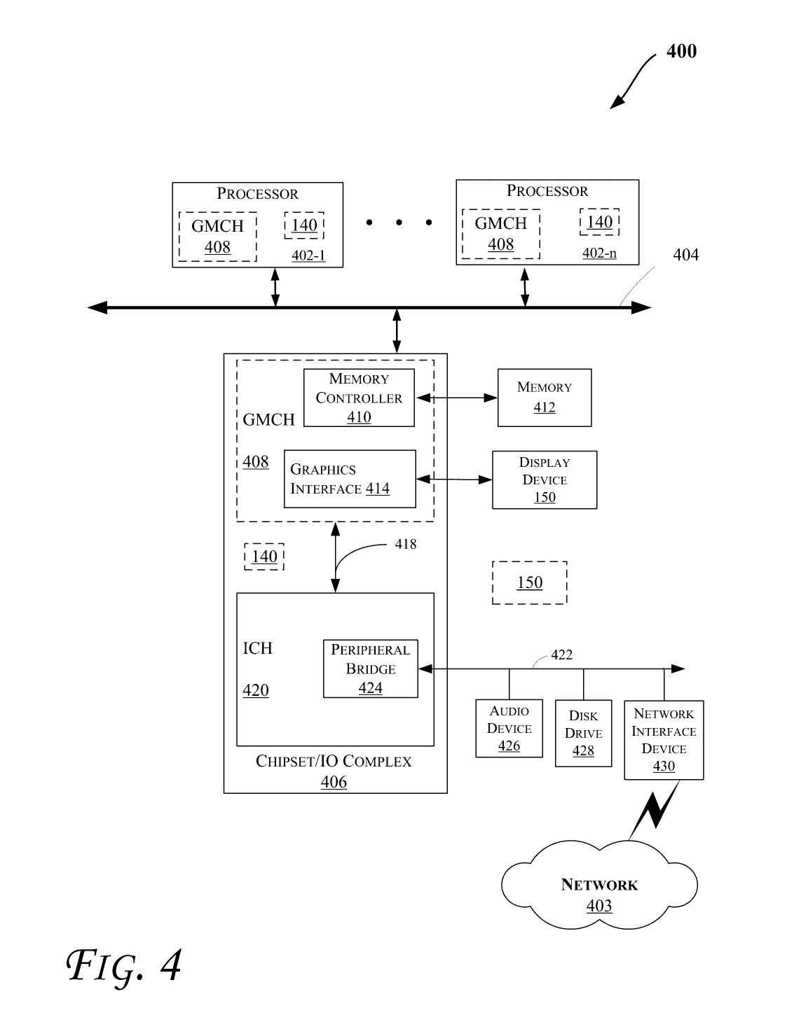

In an embodiment, the processor 102-1 may include one or more processor cores 106-1 through 106-M (referred to herein as “cores 106,” or “core 106”), a cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), graphics and/or memory controllers (such as those discussed with reference to FIGS. 4-6), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. In an embodiment, the cache 108 (that may be shared) may be a mid-level cache (MLC), a last level cache (LLC), etc. Also, each of the cores 106 may include a level 1 (L1) cache (116-1) (generally referred to herein as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

As shown, system 100 may also include one or more load/force sensors 150 to detect force, weight, load, etc. such as discussed herein. Sensor(s) 150 may be integrated into the chassis of a portable computing device in some embodiments, such as those discussed with reference to the remaining figures. System 100 also includes logic 140 to receive information from the sensor(s) 150 and cause execution of various operations based at least in part on the received information.

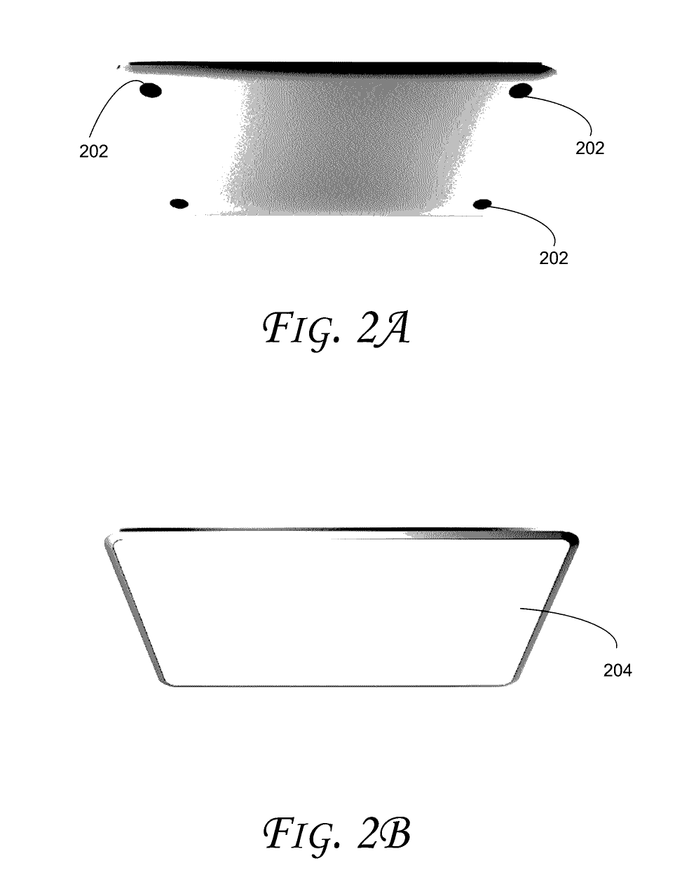

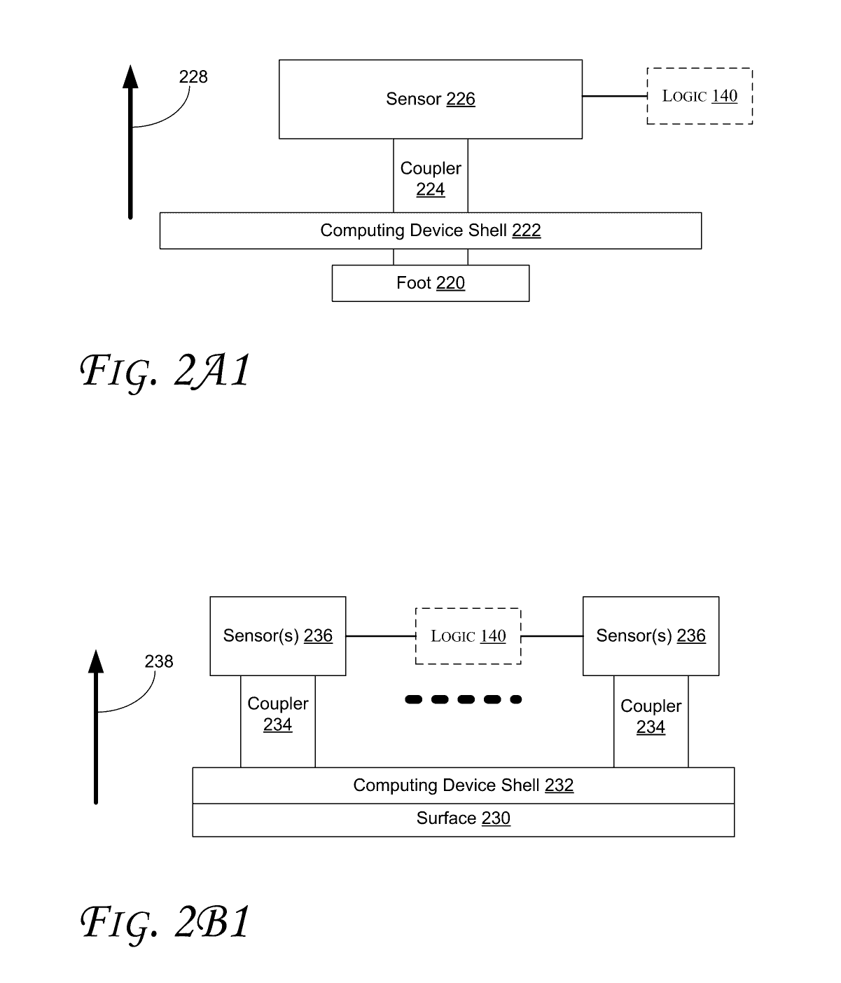

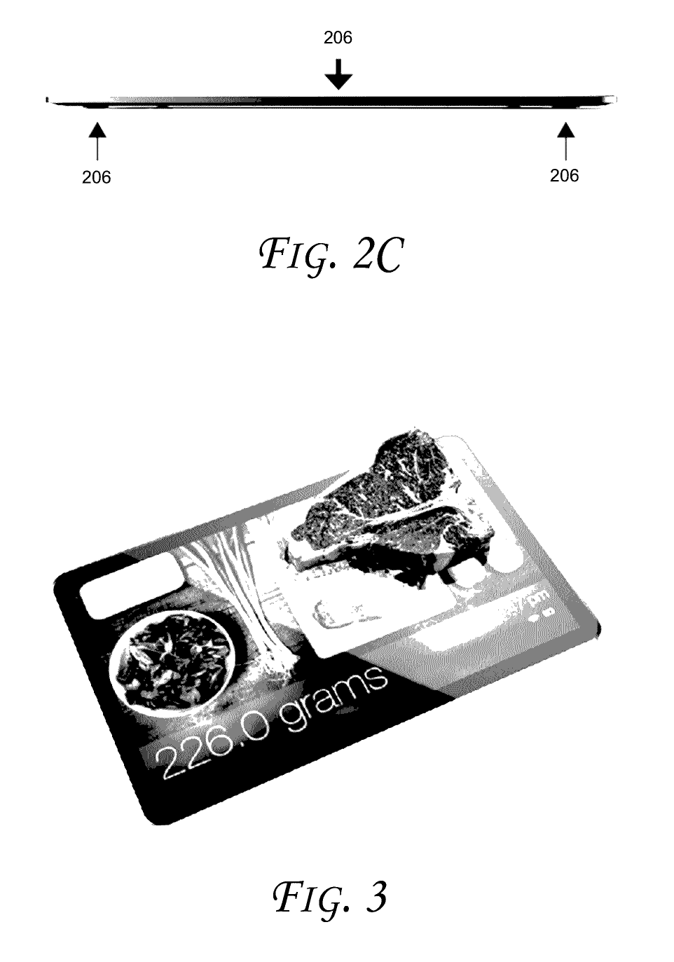

FIG. 2A illustrates a bottom view of a portable computing device with force transducers; according to an embodiment. FIG. 2A shows how device feet might act as load sensors 202. The load sensors 202 may be integrated into device fee (shown as dark circles in FIG. 2A). Also, while FIG. 2A shows four feet, more or less number of device feet may be used. Further, load sensors 202 may be integrated in one or more of the feet (e.g., not all feet may integrate a load sensor). In an embodiment, the feet/load sensors 202 might be associated individually with one or more force sensors and the sum total output of those sensors may be read by logic 140 to determine the weight of an item. Furthermore, the feet/load sensors 202 might be structurally connected inside the enclosure of the computing system, and one force sensor may read the total force detected by one or more other force sensors.

FIG. 2A1 illustrates a side view of some components of the load sensor 202 of FIG. 2A, according to an embodiment. As shown, the load sensor may include a foot 220 which may be in contact with a (e.g., rigid) surface to facilitate detection of force incident on the load sensor. Foot 220 is attached to a coupler 224 which is in turn attached to a sensor 226 (that may be the same or similar to the sensor(s) 150 discussed with reference to the other figures). As shown in FIG. 2A1, coupler 224 may protrude through an opening in the shell or skin of a computing device (222) such as the computing devices discussed herein with reference to the other figures. In an embodiment, the coupler 224 may be omitted and the foot 220 may be directly coupled to the sensor 226. The embodiment of FIG. 2A1 allows the foot 220 to receive incident force and communicate the incident force (e.g., in terms of linear displacement in the direction of arrow 228), e.g., through the coupler 224, to the sensor 226. The sensor 226 may then translate the amount of incident force into a value (e.g., processed by logic 140) indicative of the weight of an object placed on the top surface of the computing device, such as discussed with reference to FIGS. 2C and/or 3.

FIG. 2B illustrates a bottom view of a portable computing device with a sensor surface; according to an embodiment. FIG. 2A shows how the entire ‘D-Surface’ might act as a sensor or otherwise float on load sensors (such as load sensors 236 of FIG. 2B1, e.g., provided below surface 204) to measure weight. While the sensing surface 204 is shown to include substantially one entire side of the portable device, a smaller surface portion (having a rectangular, circular, or other shapes) may also be used. In one embodiment, surface 204 is a floating base that might have one centrally mounted sensor or three to four (or more) sensors either mounted at the corners or mid spans of the long edges of the surface 204. Also, in an embodiment, weight may be detected by a force touch-screen.

FIG. 2B1 illustrates a side view of some components of the sensing surface 204 of FIG. 2B, according to an embodiment. As shown, the sensing surface may include a surface 230 which may be in contact with a (e.g., rigid) surface to facilitate detection of force incident on the sensing surface (e.g., when the surface 230 is facing downward). Alternatively, the surface 230 may receive/hold the item whose weight is to be measured (e.g., when the surface is facing up). Surface 230 is attached to one or more couplers 234 which are in turn attached to one or more sensors 236 (that may be the same or similar to the sensor(s) 150 discussed with reference to the other figures). As shown in FIG. 2B1, coupler(s) 234 may protrude through an opening in the shell or skin of a computing device (232) such as the computing devices discussed herein with reference to the other figures. In an embodiment, coupler(s) 234 may be omitted and the surface 230 may be directly coupled to the sensor(s) 236. The embodiment of FIG. 2B1 allows the surface 230 to receive incident force and communicate the incident force (e.g., in terms of linear displacement in the direction of arrow 238), e.g., through the coupler(s) 234, to the sensor(s) 236. The sensor(s) 236 may then translate the amount of incident force into a value (e.g., processed by logic 140) indicative of the weight of an object placed on the top surface of the computing device, such as discussed with reference to FIGS. 2C and/or 3. In an embodiment, sensors 236 might be structurally connected inside the enclosure of the computing system, and one force sensor may read the total force detected by one or more other force sensors.

FIG. 2C illustrates a side view of a portable computing device, according to an embodiment. Arrows 206 indicate sample loading spots on the portable computing device that may integrate force transducers to measure weight. For example, the weight of an object sitting on the top surface of the portable computing device may be measured by taking the detected values at sensors 206 (on the top and against, e.g., a rigid surface on the bottom) integrated into the portable computing device.

FIG. 3 illustrates a sample user interface that might be invoked when measuring weight for cooking, according to an embodiment. For example, various ingredients for a recipe may be displayed on the portable computing device's flat screen or touchscreen (e.g., in a proportions corresponding to the amount of each ingredient). More particularly, one or more load sensor(s) 150 (such as those discussed with reference to FIGS. 2A-2C) may generate signal(s) corresponding to the detected force at each sensor and send the signal(s) to the logic 140 for utilization by a software application (or operating system) of the portable computing device. While FIG. 3 discusses a cooking application, embodiments may be applied to other types of applications such as chemical recipes, postal measurements, assembly instructions, etc.

In an embodiment, the portable computing device includes a force sensitive touchscreen (such as shown in FIG. 3), where the amount of force applied to the touchscreen would be measurable (e.g., by sensor(s) 150 discussed herein). Also, the portable computing device may be a field tablet to withstand utilization in hostile environments such as a kitchen, a plant, in proximity to water or rain, etc.

Moreover, by integrating force transducers into the chassis exposed in the form of discrete feet or as part of a floating ‘D-surface’ a user could measure weight for a wide range of applications from consumer kitchen weigh scales to perhaps more specialist lab-based applications. The usual leveraging of online data could allow for example weighing mail displaying prevailing or available postal shipping/rate options, e.g., to give the user cost information of stamps. Other commodities of varying value might work too. In one embodiment, integrated gravity sensors (e.g., not shown but could be used in a similar fashion as or otherwise integrated with sensor(s) 150) would recalibrate to tare for use on non-level surfaces.

In another example, information obtained from a computer network (or the Internet) may link use as bathroom scales to wearable fitness devices for health monitoring or back to the kitchen for dietary suggestions and recommended calorie intake when cooking from recipes. Such embodiments open the scope of usages for portable/tablet type devices to weigh anything from the illicit to everyday banal items like drugs, cooking ingredients, postal mail, etc.

FIG. 4 illustrates a block diagram of a computing system 400 in accordance with an embodiment. The computing system 400 may include one or more Central Processing Units (CPUs) 402 or processors that communicate via an interconnection network (or bus) 404. The processors 402 may include a general purpose processor, a network processor (that processes data communicated over a computer network 403), or other types of a processor (including a reduced instruction set computer (RISC) processor or a complex instruction set computer (CISC)).

Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors. In an embodiment, one or more of the processors 402 may be the same or similar to the processors 102 of FIG. 1. Further, one or more components of system 400 may include logic 140 coupled to the sensor(s) 150, discussed with reference to FIGS. 1-3 (including but not limited to those locations illustrated in FIG. 4). Also, the operations discussed with reference to FIGS. 1-3 may be performed by one or more components of the system 400.

A chipset 406 may also communicate with the interconnection network 404. The chipset 406 may include a graphics memory control hub (GMCH) 408, which may be located in various components of system 400 (such as those shown in FIG. 4). The GMCH 408 may include a memory controller 410 that communicates with a memory 412 (which may be the same or similar to the memory 114 of FIG. 1). The memory 412 may store data, including sequences of instructions, that may be executed by the CPU 402, or any other device included in the computing system 400. In one embodiment, the memory 412 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 404, such as multiple CPUs and/or multiple system memories.

The GMCH 408 may also include a graphics interface 414 that communicates with the display device. In one embodiment, the graphics interface 414 may communicate with a display device via an accelerated graphics port (AGP) or Peripheral Component Interconnect (PCI) (or PCI express (PCIe) interface). In an embodiment, the display (such as a flat panel display) may communicate with the graphics interface 414 through, for example, a signal converter that translates a digital representation of an image stored in a storage device such as video memory or system memory into display signals that are interpreted and displayed by the display device. The display signals produced by the display device may pass through various control devices before being interpreted by and subsequently displayed on the display device.

A hub interface 418 may allow the GMCH 408 and an input/output control hub (ICH) 420 to communicate. The ICH 420 may provide an interface to I/O device(s) that communicate with the computing system 400. The ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the CPU 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and a network interface device 430 (which is in communication with the computer network 403). Other devices may communicate via the bus 422. Also, various components (such as the network interface device 430) may communicate with the GMCH 408 in some embodiments. In addition, the processor 402 and the GMCH 408 may be combined to form a single chip. Furthermore, a graphics accelerator may be included within the GMCH 408 in other embodiments.

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

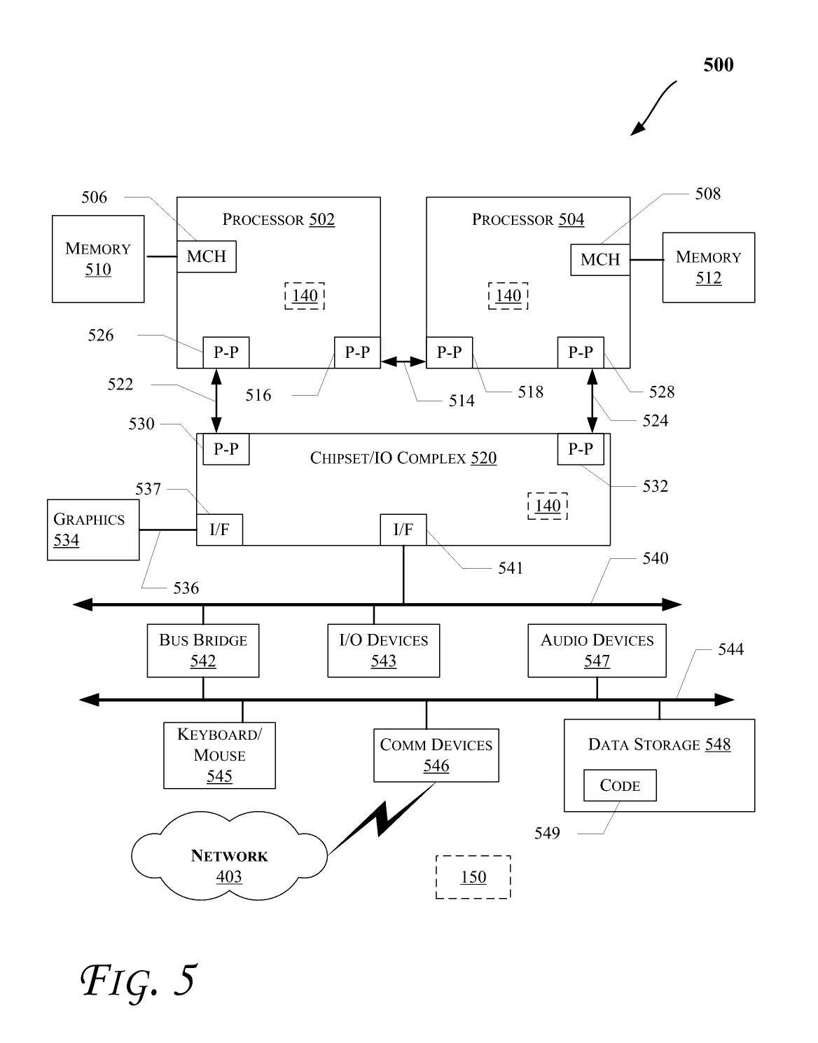

FIG. 5 illustrates a computing system 500 that is arranged in a point-to-point (PtP) configuration, according to an embodiment. In particular, FIG. 5 shows a system where processors, memory, and input/output devices are interconnected by a number of point-to-point interfaces. The operations discussed with reference to FIGS. 1-4 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to enable communication with memories 510 and 512. The memories 510 and/or 512 may store various data such as those discussed with reference to the memory 412 of FIG. 4.

In an embodiment, the processors 502 and 504 may be one of the processors 402 discussed with reference to FIG. 4. The processors 502 and 504 may exchange data via a point-to-point (PtP) interface 514 using PtP interface circuits 516 and 518, respectively. Also, the processors 502 and 504 may each exchange data with a chipset 520 via individual PtP interfaces 522 and 524 using point-to-point interface circuits 526, 528, 530, and 532. The chipset 520 may further exchange data with a graphics circuit 534 via a graphics interface 536, e.g., using a PtP interface circuit 537.

At least one embodiment may be provided within the processors 502 and 504. Further, one or more components of system 500 may include logic 140 coupled to the sensor(s) 150, discussed with reference to FIGS. 1-4 (including but not limited to those locations illustrated in FIG. 5). Other embodiments, however, may exist in other circuits, logic units, or devices within the system 500 of FIG. 5. Furthermore, other embodiments may be distributed throughout several circuits, logic units, or devices illustrated in FIG. 5.

The chipset 520 may communicate with a bus 540 using a PtP interface circuit 541. The bus 540 may communicate with one or more devices, such as a bus bridge 542 and I/O devices 543. Via a bus 544, the bus bridge 542 may communicate with other devices such as a keyboard/mouse 545, communication devices 546 (such as modems, network interface devices, or other communication devices that may communicate with the computer network 403), audio I/O device 547, and/or a data storage device 548. The data storage device 548 may store code 549 that may be executed by the processors 502 and/or 504.

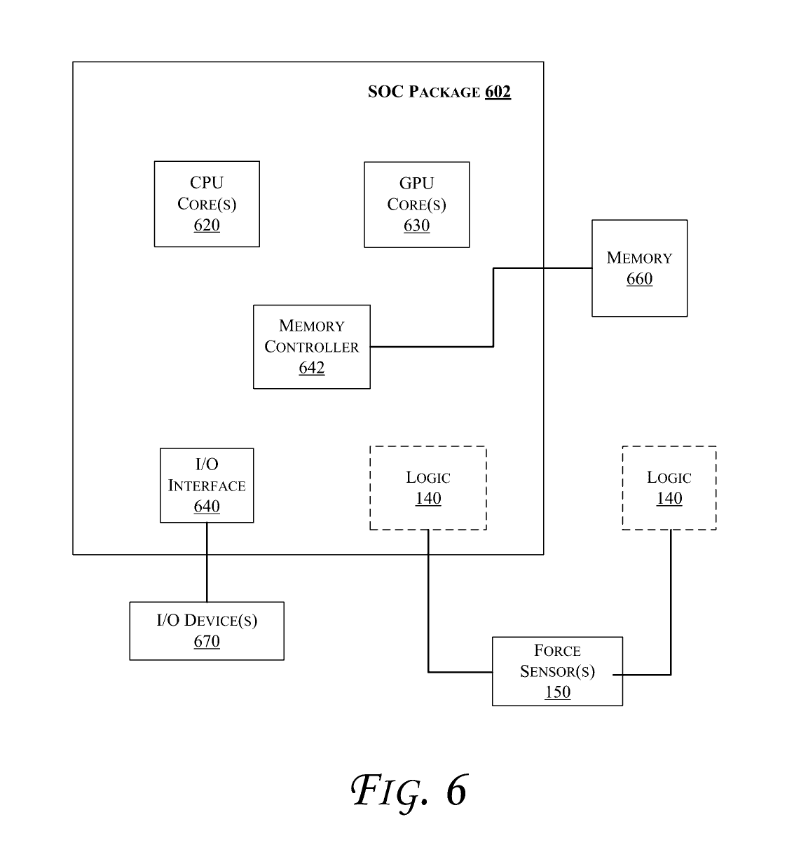

In some embodiments, one or more of the components discussed herein can be embodied as a System On Chip (SOC) device. FIG. 6 illustrates a block diagram of an SOC package in accordance with an embodiment. As illustrated in FIG. 6, SOC 602 includes one or more Central Processing Unit (CPU) cores 620, one or more Graphics Processing Unit (GPU) cores 630, an Input/Output (I/O) interface 640, and a memory controller 642. Various components of the SOC package 602 may be coupled to an interconnect or bus such as discussed herein with reference to the other figures. Also, the SOC package 602 may include more or less components, such as those discussed herein with reference to the other figures. Further, each component of the SOC package 620 may include one or more other components, e.g., as discussed with reference to the other figures herein. In one embodiment, SOC package 602 (and its components) is provided on one or more Integrated Circuit (IC) die, e.g., which are packaged into a single semiconductor device.

As illustrated in FIG. 6, SOC package 602 is coupled to a memory 660 (which may be similar to or the same as memory discussed herein with reference to the other figures) via the memory controller 642. In an embodiment, the memory 660 (or a portion of it) can be integrated on the SOC package 602.

The I/O interface 640 may be coupled to one or more I/O devices 670, e.g., via an interconnect and/or bus such as discussed herein with reference to other figures. I/O device(s) 670 may include one or more of a keyboard, a mouse, a touchpad, a display device, an image/video capture device (such as a camera or camcorder/video recorder), a touch screen, a speaker, or the like. Furthermore, SOC package 602 may include/integrate logic 140 and/or sensor(s) 150 in some embodiments. Alternatively, logic 140 and/or sensor(s) 150 may be provided outside of the SOC package 602 (i.e., as a discrete logic).

Moreover, the scenes, images, or frames discussed herein (e.g., which may be processed by the graphics logic in various embodiments) may be captured by an image capture device (such as a digital camera (that may be embedded in another device such as a smart phone, a tablet, a laptop, a stand-alone camera, etc.) or an analog device whose captured images are subsequently converted to digital form). Moreover, the image capture device may be capable of capturing multiple frames in an embodiment. Further, one or more of the frames in the scene are designed/generated on a computer in some embodiments. Also, one or more of the frames of the scene may be presented via a display (such as the display discussed with reference to FIGS. 4 and/or 5, including for example a flat panel display device, etc.).

The following examples pertain to further embodiments. Example 1 includes an apparatus comprising: logic, the logic at least partially comprising hardware logic, to receive a load detection signal from one or more load sensors coupled to a mobile computing device, wherein the one or more load sensors are to be integrated into a chassis of the mobile computing device. Example 2 includes the apparatus of example 1, wherein the one or more load sensors are to be coupled to a bottom surface of the mobile computing device. Example 3 includes the apparatus of example 1, wherein the one or more load sensors are to comprise a sensor surface or be integrated into a sensor surface of the mobile computing device. Example 4 includes the apparatus of example 1, wherein the mobile computing device is to comprise a flat screen to display one or more images in response to the load detection signal. Example 5 includes the apparatus of example 4, wherein the flat screen is to comprise a touchscreen. Example 6 includes the apparatus of example 1, wherein the one or more load sensors are to be integrated into the chassis of the mobile computing device as device feet. Example 7 includes the apparatus of example 1, wherein the load detection signal is to correspond to force detected at the one or more load sensors. Example 8 includes the apparatus of example 1, wherein the logic is to transmit information corresponding to the load detection signal to a software application or an operating system. Example 9 includes the apparatus of example 8, wherein the mobile computing device is to comprise a processor, having one or more processor cores, to execute code corresponding to the software application or the operating system. Example 10 includes the apparatus of example 8, further comprising memory to store the information. Example 11 includes the apparatus of example 8, further comprising memory to store code corresponding to the software application or the operating system. Example 12 includes the apparatus of example 1, wherein the mobile computing device is to comprise the logic. Example 13 includes the apparatus of example 1, wherein the mobile computing device is to comprise one of: a smartphone, a tablet, a UMPC (Ultra-Mobile Personal Computer), a laptop computer, an Ultrabook™ computing device, and a wearable device. Example 14 includes the apparatus of example 1, wherein a processor, having one or more processor cores, is to comprise the logic. Example 15 includes the apparatus of example 1, wherein one or more of the logic, a processor having one or more processor cores, and memory are on a single integrated circuit die.

Example 16 includes a method comprising: receiving a load detection signal from one or more load sensors coupled to a mobile computing device, wherein the one or more load sensors are integrated into a chassis of the mobile computing device. Example 17 includes the method of example 16, further comprising generating the load detection signal in response to force detected at the one or more load sensors. Example 18 includes the method of example 16, further comprising transmitting information corresponding to the load detection signal to a software application or an operating system.

Example 19 includes a system comprising: a mobile computing device having memory to store data; logic to receive a load detection signal from one or more load sensors coupled to the mobile computing device, wherein the one or more load sensors are to be integrated into a chassis of the mobile computing device. Example 20 includes the system of example 19, wherein the one or more load sensors are to comprise a sensor surface or be integrated into a sensor surface of the mobile computing device. Example 21 includes the system of example 19, wherein the memory is to information corresponding to the load detection signal.

Example 22 includes a computer-readable medium comprising one or more instructions that when executed on a processor configure the processor to perform one or more operations to: receive a load detection signal from one or more load sensors coupled to a mobile computing device, wherein the one or more load sensors are integrated into a chassis of the mobile computing device. Example 23 includes the computer-readable medium of example 22, further comprising one or more instructions that when executed on the processor configure the processor to perform one or more operations to cause generation of the load detection signal in response to force detected at the one or more load sensors. Example 24 includes the computer-readable medium of example 22, further comprising one or more instructions that when executed on the processor configure the processor to perform one or more operations to cause transmission of information corresponding to the load detection signal to a software application or an operating system. Example 25 includes the computer-readable medium of example 24, further comprising one or more instructions that when executed on the processor configure the processor to perform one or more operations to cause storage of code corresponding to the software application or the operating system.

Example 26 includes an apparatus comprising means to perform a method as set forth in any preceding example. Example 27 comprises machine-readable storage including machine-readable instructions, when executed, to implement a method or realize an apparatus as set forth in any preceding example.

In various embodiments, the operations discussed herein, e.g., with reference to FIGS. 1-6, may be implemented as hardware (e.g., logic circuitry), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIGS. 1-6.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
logic, the logic at least partially comprising hardware logic, to receive a load detection signal from one or more load sensors coupled to a mobile computing device,
wherein the one or more load sensors are to be integrated into a chassis of the mobile computing device.

2. The apparatus of claim 1, wherein the one or more load sensors are to be coupled to a bottom surface of the mobile computing device.

3. The apparatus of claim 1, wherein the one or more load sensors are to comprise a sensor surface or be integrated into a sensor surface of the mobile computing device.

4. The apparatus of claim 1, wherein the mobile computing device is to comprise a flat screen to display one or more images in response to the load detection signal.

5. The apparatus of claim 4, wherein the flat screen is to comprise a touchscreen.

6. The apparatus of claim 1, wherein the one or more load sensors are to be integrated into the chassis of the mobile computing device as device feet.

7. The apparatus of claim 1, wherein the load detection signal is to correspond to force detected at the one or more load sensors.

8. The apparatus of claim 1, wherein the logic is to transmit information corresponding to the load detection signal to a software application or an operating system.

9. The apparatus of claim 8, wherein the mobile computing device is to comprise a processor, having one or more processor cores, to execute code corresponding to the software application or the operating system.

10. The apparatus of claim 8, further comprising memory to store the information.

11. The apparatus of claim 8, further comprising memory to store code corresponding to the software application or the operating system.

12. The apparatus of claim 1, wherein the mobile computing device is to comprise the logic.

13. The apparatus of claim 1, wherein the mobile computing device is to comprise one of: a smartphone, a tablet, a UMPC (Ultra-Mobile Personal Computer), a laptop computer, an Ultrabook™ computing device, and a wearable device.

14. The apparatus of claim 1, wherein a processor, having one or more processor cores, is to comprise the logic.

15. The apparatus of claim 1, wherein one or more of the logic, a processor having one or more processor cores, and memory are on a single integrated circuit die.

16. A method comprising:
receiving a load detection signal from one or more load sensors coupled to a mobile computing device,
wherein the one or more load sensors are integrated into a chassis of the mobile computing device.

17. The method of claim 16, further comprising generating the load detection signal in response to force detected at the one or more load sensors.

18. The method of claim 16, further comprising transmitting information corresponding to the load detection signal to a software application or an operating system.

19. A system comprising:
a mobile computing device having memory to store data;
logic to receive a load detection signal from one or more load sensors coupled to the mobile computing device,
wherein the one or more load sensors are to be integrated into a chassis of the mobile computing device.

20. The system of claim 19, wherein the one or more load sensors are to comprise a sensor surface or be integrated into a sensor surface of the mobile computing device.

21. The system of claim 19, wherein the memory is to information corresponding to the load detection signal.

22. A computer-readable medium comprising one or more instructions that when executed on a processor configure the processor to perform one or more operations to:
receive a load detection signal from one or more load sensors coupled to a mobile computing device,
wherein the one or more load sensors are integrated into a chassis of the mobile computing device.

23. The computer-readable medium of claim 22, further comprising one or more instructions that when executed on the processor configure the processor to perform one or more operations to cause generation of the load detection signal in response to force detected at the one or more load sensors.

24. The computer-readable medium of claim 22, further comprising one or more instructions that when executed on the processor configure the processor to perform one or more operations to cause transmission of information corresponding to the load detection signal to a software application or an operating system.

25. The computer-readable medium of claim 24, further comprising one or more instructions that when executed on the processor configure the processor to perform one or more operations to cause storage of code corresponding to the software application or the operating system.
